(19) United States
(12) Patent Application Publication
(10) Pub. No.: US 2021/0142427 A1
(43) Pub. Date: May 13, 2021

(54) SYSTEM TO MANAGE PROPERTY PROFILES

(71) Applicant: Jonathan Credendino, New Rochelle, NY (US)

(72) Inventor: Jonathan Credendino, New Rochelle, NY (US)

(21) Appl. No.: 16/795,030

(22) Filed: Feb. 19, 2020

Related U.S. Application Data
(60) Provisional application No. 62/934,218, filed on Nov. 12, 2019.

(51) Int. Cl. G06Q 50/08; G06F 21/31; G06Q 50/16

(52) U.S. Cl. CPC G06Q 50/08; G06Q 50/163; G06F 21/31

(57) ABSTRACT

A computing device for implementing a method for managing property profiles is described. A request associated with a property having a first unique identifier is received via an engine of a client portal from a first user. The request is transmitted to a property database housing property profiles. A property profile housing identifiable information associated with the property and having a second unique identifier that matches the first unique identifier is received from the property database. The property profile is transmitted to the client portal for display to the first user. A second user is notified of the request from the first user. The second user has a second access level to the property profile based on an authenticated identity of the second user. The second user then modifies the property profile based on the request of the first user.

### CROSS-REFERENCE TO RELATED APPLICATIONS

This Application claims priority to U.S. Provisional Application No. 62/934,218 filed Nov. 12, 2019. The disclosure of the prior application is hereby incorporated by reference herein in its entirety.

### FIELD OF THE EMBODIMENTS

The field of the invention and its embodiments relate to methods to maintain and manage property profiles. In particular, the present invention and its embodiments describe a stream-lined system that provides building consultation services, preventative services, compliance services, management services, and maintenance services for a property. The present invention also provides deployment services for any issue (such as a construction issue) that may arise in a building.

### BACKGROUND OF THE EMBODIMENTS

Proper property management requires paying attention to development services (such as surveying services and architectural services), as well as construction services (such as plumbing and maintenance services) for the building. Proper management of a construction service associated with a building may require hiring specially licensed individuals and ensuring that the hired individuals comply with any regulatory procedures. If the regulatory procedures are not properly performed or if the regulatory procedures are performed by non-licensed workers, fines or penalty may be imposed on construction companies, construction workers, inspectors, and/or property owners, depending on the regulatory rules.

Moreover, if the management team wishes to ensure that the building does not fail any building, fire, and/or environmental code violations, the management team may have to hire other individuals having different certifications or licenses from those workers hired for one or more construction services on the property. Further, the management team may be unaware or unsure of what specific codes the building must comply with. As can be seen, management of a property may be quite time consuming and may require the hiring of multiple individuals with different licenses, certifications, and/or skills.

Thus, a need exists for a stream-lined system that provides building consultation services, preventative services, compliance services, management services, and maintenance services for a property. The present invention also provides deployment services for any issue (such as a construction issue) that may arise in a building. A need also exists for creation of a property profile, accessible by a user via a client portal, to store identifiable information associated with the property and to receive requests from the user for services to be rendered on the property.

### Review of Related Technology:

U.S. Published Patent Application No. 2018/0060981 A1 describes a network-leveraged real estate transaction assistance system that is configured to facilitate matching, engaging, contracting, and communicating between parties to a real estate and/or property rental transaction by a network-leveraged system.

U.S. Published Patent Application No. 2011/0288969 A1 describes a computer system adapted to implement a method for creating and interacting with an Asset Record Container (ARC). The method includes: (1) providing an information container representing a piece of real property identified by a unique identifier, (2) providing an information transaction history representing information related to the input and output of the real property information stored by the ARC, (3) providing an ARC web portal manager adapted to allow the owner of the real property represented by the ARC to manage access to the real property information and allowing for communication and integration with third party applications, (4) providing access to the ARC according to the plurality of ARC access rules of the ARC web portal virtual manager, and (5) providing a payment transaction processing system adapted to handle receipt and payment of transaction fees relating to creating and interacting with the ARC.

WO 2018/112478 A1 describes a system and a method for construction project management graphical user interfaces (GUIs). The method includes: (1) generating a project profile for a construction project, (2) determining project details of the project, (3) determining a regulatory process to be performed during the project based on the project details and regulatory rules, (4) determining workers certificates or licenses corresponding to the regulatory process and the project details, (5) determining candidate workers for the construction project from registered workers, and (6) causing a first GUI for selection of one or more candidate workers to be generated. The first GUI includes indicators of statuses of the workers certificates or licenses corresponding to the regulatory process with respect to each of the one or more candidate workers.

U.S. Published Patent Application No. 2019/0096013 A1 describes a method for providing property management services. The method includes: (1) receiving, using a graphical user interface coupled to an electronic device, login credentials for a user for access to a digital application for providing property management services, where the electronic device is coupled to one or more secondary electronic devices through one or more servers. The method further includes: (2) authenticating, using a processor coupled to the electronic device, an identity of the user. The method additionally includes: (3) granting access to the user to a digital menu configured for the user type for the user, and (4) displaying the digital menu to the user, using the graphical user interface.

WO 2008/153978 A3 describes a method for managing real and personal property. The method includes: (1) capturing history of a (real) property, which may include a description of the property, the personal property located on the real property, the projects and maintenance performed or to be performed on the property and their impact on the owner's tax basis in the property; and (2) sharing this history with an online community or a buyer.

U.S. Published Patent Application No. 2008/0140485 A1 describes a project assessment method for implementing the assessment of large, business critical, and high risk business programs and projects.

U.S. Published Patent Application No. 2005/0222942 A1 describes management of tasks required of trade subcontractors in the construction industry.

Various references describe attempts at remedying the difficulties associated with maintaining and managing property profiles. In particular, a need exists for a stream-lined system that provides building consultation services, preventative services, compliance services, management services, and maintenance services for a property. A need also exists for the stream-lined system to provide deployment services for any issue (such as a construction issue) that may arise in a building. Additionally, a need also exists for creation of a property profile, accessible by a user via a client portal, to store identifiable information associated with the property and to receive requests from a user for services to be rendered on the property.

### Summary of the Embodiments

The present invention and its embodiments relate to a method, a computing device, and a computer system for maintaining property profiles. In particular, the present invention and its embodiments provide a stream-lined system that provides building consultation services, preventative services, compliance services, management services, and maintenance services for a property. The present invention also teaches that the stream-lined system may provide deployment services for any issue (such as a construction issue) that may arise in a building. Additionally, the present invention also teaches creation of a property profile, accessible by a user via a client portal, to store identifiable information associated with the property and to receive requests from a user for services to be rendered on the property.

In a first embodiment, a method executed by a property management application on a computing device for managing property profiles is described. According to the method, the property management application receives, via a client portal associated with the property management application, login credentials from a first user to access the client portal. The property management application then authenticates an identity of the first user based on the login credentials.

Next, the property management application may receive, via one or more engines of the client portal, a request associated with a property (associated with a first unique identifier) from the first user. The one or more engines may include a planning engine, an alert engine, a development engine, a payment transaction engine, an information engine, and/or a construction engine.

In some examples, the client portal receives the request through a planning engine. In this scenario, the request may include a plan associated with a repair project for the property, a calculation of a cost of an inspection of the property, and/or a calculation of a cost of a repair project of the property. In another example, the client portal may receive the request through an alert engine. In this example, the request may include a crime alert, a weather alert, and/or a public safety alert.

In a further example, the client portal may receive the request through a development engine. The development engine houses building code information. In this case, the request may include a request for a development service to be performed on the property, such as a surveying service, an architectural service, an engineering service, an inspection service, a consulting service, a filing service, and/or a representative service. In another example, request includes a request for building code information or building code requirements for a building located on the property.

In some examples, the client portal receives the request through a payment transaction engine. In this scenario, the request includes a request to process a payment from the first user for one or more services rendered on the property. In another example, the client portal receives the request through an information engine. In this example, the request may include a request for building code information to be provided to the first user.

In some examples, the client portal receives the request through a construction engine. In this scenario, the request is associated with a request for a construction service to be performed on the property. The construction service may include a general contracting service, a contracting service, a construction management service, a superintendent service, a plumbing service, and/or a property maintenance service.

Then, the property management application transmits the request to a property database housing property profiles. Next, the property management application may receive, from the property database, a property profile housing identifiable information associated with the property and having a second unique identifier that matches the first unique identifier of the property. The property management application may then transmit the property profile to the client portal for display to the first user on a graphical user interface (GUI) of the computing device. The first user may be granted a first access level to the property profile based on the authenticated identity of the first user.

In additional examples, the property management application may notify a second user of the request from the first user. The second user has a second access level to the property profile based on an authenticated identity of the second user. In some examples, the second access level is higher than the first access level associated with the first user. Then, the property management application may receive, from the second user, one or more modifications to the property profile based on the request.

In a second embodiment, a computer system is depicted. The computer system comprises one or more processors, one or more memories, and one or more computer-readable hardware storage devices. The one or more computer-readable hardware storage devices may contain program code executable by the one or more processors via the one or more memories to implement a method for managing property profiles.

According to the method, the computer system may receive, via a client portal, login credentials from a first user to access the client portal and may authenticate an identity of the first user based on the login credentials. The computer system may then receive, via one or more engines of the client portal, a request associated with a property from the first user, where the property includes a first unique identifier. Next, the computer system may transmit the request to a property database housing property profiles. The property database may then transmit a property profile to the computer system. The property profile may house identifiable information associated with the property and may have a second unique identifier that matches the first unique identifier of the property. The identifiable information may include: one or more photographs associated with the property, one or more videos associated with the property, an address of the property, financial information associated with the property, current and/or past owners of the property, contact information associated with the property, pending projects associated with the property, completed projects associated with the property, violations associated with the property, and/or a listing of other properties similar to the property. In some examples, the violations associated with the property may include building code violations, fire code violations, and/or environmental code violations. The violations may be violations of international, federal, local, state, and/or city laws, regulations, and/or ordinances.

Next, the computer system may transmit the property profile to the client portal for display to the first user on a graphical user interface (GUI) of the computer system. Moreover, the computer system may grant the first user a first access level to the property profile based on the authenticated identity of the first user.

In a third embodiment, a computing device is described. The computing device includes one or more processors, one or more memories, and one or more computer-readable hardware storage devices. The one or more computer-readable hardware storage devices contain program code executable by the one or more processors via the one or more memories to implement a method for managing property profiles.

According to the method, the computing device may receive, via a client portal, login credentials from a first user to access the client portal and may authenticate an identity of the first user based on the login credentials. The computing device may then receive, via one or more engines of the client portal, a request associated with a property from the first user. The property may be associated with a first unique identifier. The computing device may then transmit the request to a property database housing property profiles.

Next, the computing device may receive, from the property database, a property profile housing identifiable information associated with the property and having a second unique identifier that matches the first unique identifier of the property. The computing device may transmit the property profile to the client portal for display to the first user.

In some examples, the computing device may also grant the first user a first access level to the property profile based on the authenticated identity of the first user. In other examples, the computing device may notify a second user of the request from the first user. The second user has a second access level to the property profile based on an authenticated identity of the second user. In some examples, the second access level is higher than the first access level. The identity of the second user may be authenticated as an administrator, an owner of the property, a tenant, a prospective buyer of the property, a prospective tenant of the property, a prospective vendor for the property, a vendor, a landlord, or a prospective landlord of the property.

In an illustrative example, the identity of the second user is authenticated as the administrator. In this example, the computing device may receive, from the second user, one or more modifications to the property profile based on the request. The one or more modifications may include: entering a service ticket associated with a project to be performed on the property, modifying the service ticket associated with the project to be performed on the property, monitoring a status of the service ticket associated with the project to be performed on the property, deleing the service ticket associated with the project performed on the property, entering a subset of identifiable information associated with the property, modifying the subset of the identifiable information associated with the property, deleting the subset of the identifiable information associated with the property, removing one or more documents associated with the property, modifying the one or more documents associated with the property, and/or uploading the one or more documents associated with the property. The method may further include transmitting the modified property profile to the property database for storage. The modified property profile may also be transmitted to the client portal for display to the first user.

In another example, the identity of the user may be authenticated as the vendor. In this example, the computing device may receive, from the second user, one or more modifications to the property profile based on the request. The one or more modifications may include: reading a service ticket of a project associated with the property and/or modifying a status of the service ticket of the property. The method may further include transmitting the modified property profile to the property database for storage. The modified property profile may also be transmitted to the client portal for display to the first user.

In general, the present invention succeeds in conferring the following benefits and objectives.

It is an object of the present invention to provide a stream-lined system that provides building consultation services for a property.

It is an object of the present invention to provide a stream-lined system that provides preventative services for a property.

It is an object of the present invention to provide a stream-lined system that provides compliance services for a property.

It is an object of the present invention to provide a stream-lined system that provides management services for a property.

It is an object of the present invention to provide a stream-lined system that provides maintenance services for a property.

It is an object of the present invention to provide a stream-lined system that provides deployment services for any issue (such as a construction issue) that may arise in a building.

It is an object of the present invention to provide a user-friendly property profile, accessible by a user via a user or client portal, that stores identifiable information associated with the property.

It is an object of the present invention to provide a user-friendly property profile, accessible by a user via a user or client portal, that receives requests from a user for services to be rendered on the property.

### BRIEF DESCRIPTION OF THE DRAWINGS

FIG. 1 illustrates a detailed block diagram of a computer system configured to execute a method for managing property profiles, in accordance with embodiments of the present invention.

FIG. 2 illustrates a detailed block diagram of a client portal of a computing device, the computing device being configured to execute a method for managing property profiles, in accordance with embodiments of the present invention.

FIG. 3 illustrates a detailed block diagram of a property database configured to communicate with a computing device, the computing device being configured to execute a method for managing property profiles, in accordance with embodiments of the present invention.

FIG. 4 is a block diagram of a computing device configured to manage property profiles, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

FIG. 1 illustrates a detailed block diagram of a computer system configured to execute a method for managing property profiles, in accordance with embodiments of the present invention.

According to FIG. 1, a detailed block diagram of a computer system 100 configured to execute a method for managing property profiles 116 is depicted. The computer system 100 may include a computing device 104 configured to communicate with a first user 102, a second user 160, and a property database 114. The computing device 104 may be a laptop computer, a smartphone, a desktop computer, or a tablet computer, among others. In some examples, the computing device 104 may be part of a computer system.

The computing device 104 may include a property management application 110, which may comprise a client portal 112. The property management application 110 may be configured to provide numerous services to the first user 102, such as building consultation services, preventative services, compliance services, management services, deployment services, and/or maintenance services for a property 152 during a time period, as will be described infra.

The property management application 110 may receive, via the client portal 112 of the property management application 110, login credentials from the first user 102 to access the client portal 112. The login credentials may include a username, a password, a name of the first user 102, and/or a fingerprint authentication, among other login credentials not explicitly listed herein. Then, the property management application 110 may authenticate an identity of the first user 102 based on the login credentials.

The first user 102 may engage with the client portal 112 to access one or more engines or modules, such as a planning engine 120, an alert engine 122, a development engine 124, a payment transaction engine 156, an information engine 158, and/or a construction engine 126 to request one or more service items be performed on the property 152 or to view the one or more service items that have been performed on the property 152 at one time or another. These engines and modules will be discussed in more detail in FIG. 2.

Next, the property management application 110 may receive, via the engine (e.g., the planning engine 120) of the client portal 112, a request associated with the property 152 from the first user 102. The property 152 may be identified by a first unique identifier 154, such as a number, a combination of letters, and/or a combination of letters and numbers, among other examples not explicitly listed herein. The request may include a request to view identifiable information 130 associated with the property 152. The identifiable information 130 may include: one or more photographs associated with the property 152, one or more videos associated with the property 152, the first unique identifier 154 associated with the property 152, a second unique identifier 132 associated with the property 152, an address 134 of the property 152, contact information 138 associated with the property 152, a method by which to access the property 152 (e.g., “the property 152 requires keycard access to view the property 152”), a survey associated with the property 152, projects 140 associated with the property 152, pending projects 142 associated with the property 152, completed projects 144 associated with the property 152, financial information associated with the property 152, current or past owners 136 of the property 152, violations 146 associated with the property 152, and/or a listing of other properties similar to the property 152.

The violations 146 associated with the property may include: building code violations 148, fire code violations 151, environmental code violations 153, and/or safety/public health code violations 155. It should be appreciated that the violations 146 may be violations of international, federal, local, state, and/or city laws, regulations, and/or ordinances.

Specifically, examples of the building code violations 148 may include: a violation of an international building code, a violation of an international residential code, and/or a violation of an international plumbing code. It should be appreciated that states may adopt one or more of these international codes or may adopt a variation of one or more of the international codes described supra. As such, the building code violations may additionally or alternatively include a violation of a local, a state, and/or a city building code.

It should be appreciated that the state building code violation may be a building code violation associated with any of the states in the United States of America and the city building code violation may be a building code violation associated with any city in the United States of America, such as New York City (NYC), Los Angeles, Chicago, Houston, Phoenix, Philadelphia, San Antonio, San Diego, Dallas, San Jose, Austin, Jacksonville, Fort Worth, Columbus, San Francisco, Charlotte, Indianapolis, Seattle, Denver, Boston, El Paso, Detroit, Nashville, Portland, Memphis, Oklahoma City, Las Vegas, Louisville, Baltimore, Milwaukee, Albuquerque, Tucson, Fresno, Mesa, Sacramento, Atlanta, Kansas City, Colorado Springs, Miami, Raleigh, Omaha, Long Beach, Virginia Beach, Oakland, Minneapolis, Tulsa, Arlington, Tampa, and/or New Orleans, among other cities not explicitly listed herein.

As an illustrative example, the state building code violation may be a violation of the California Building Code, a violation of the Arkansas Building Code, and/or a violation of the New York State Building Code, among others not explicitly listed herein. As another illustrative example, the city building code violation may include a violation of the NYC Department of Buildings (DOB) code, a violation of the City of Chicago Department of Buildings (DOB) code, a violation of the NYC Housing Preservation and Development (HPD) code, and/or a violation of the Philadelphia Building Construction and Occupancy Code, among others not explicitly listed herein.

Further, the fire code violations 151 and/or the environmental code violations 153 may include a violation of a federal and/or an international code, law, regulation, and/or ordinance. As an example, the fire code violations 151 may include a state fire code violation, such as: a violation of the Minnesota Fire Code, a violation of Connecticut's State Fire Prevention Code, a violation of Connecticut's State Fire Safety Code, and/or a violation of California's Fire Code, etc. In additional examples, the fire code violations 151 may include a city fire code violation, such as: a violation of the Fire Code of Los Angeles, a violation of the Phoenix Fire Code, and/or a violation of the NYC Fire Department code.

In another example, the environmental code violations 153 may include a violation of a federal environmental code, such as a violation of the U.S. Clean Water Act (CWA). Further, the environmental code violations 153 may include a state environmental code violation, such as: a violation of the State Environmental Code of Massachusetts and/or a violation of the New York State Department of Environmental Conservation (DEC), among others. In other examples, the environmental code violations 153 may include a city environmental code violation, such as: a violation of the NYC Department of Environmental Protection (DEP) code.

Examples of the safety/public health code violations 155 may include a violation of a state law, regulation, and/or ordinance, such as a violation of the New York State Department of Health (DOH) and/or a violation of the New York State Department of Transportation (DOT), among others not explicitly listed herein. Furthermore, examples of the safety/public health code violations 155 may include a violation of a city law, regulation, and/or ordinance, such as a violation of the City of New York Department of Sanitation (DSNY) and/or a violation of the Department of Public Health (CDPH) of Chicago, among others not explicitly listed herein. It should be appreciated that the examples of violations 146 and the identifiable information listed herein is non-exhaustive and additional examples and/or information is contemplated.

The property management application 110 may transmit the request to a property database 114 housing property profiles 116 (e.g., a property profile A 128 and/or a property profile B 150 of FIG. 3). Then, the property management application 110 may receive, from the property database 114, the property profile A 128 housing the identifiable information 130 associated with the property 152 and having the second unique identifier 132 that matches the first unique identifier 154 of the property 152. The property management application 110 may then transmit the property profile A 128 to the client portal 112 for display to the first user 102 on a graphical user interface (GUI) 106 of the computing device 104.

The property management application 110 may also grant the first user 102 a first access level to the property profile A 128 based on an authenticated identity of the first user 102. For example, the first user 102 may be identified, based on the authentication, as an administrator, an owner of the property 152, a tenant of the property 152, a prospective buyer of the property 152, a prospective tenant of the property 152, a prospective vendor for the property 154, a vendor of the property 152, a landlord of the property 152, or a prospective landlord of the property 152. In an example, if the first user 102 is identified and authenticated as the administrator, the first user 102 may have an enhanced or a greater access level than if the first user 102 is identified as the tenant. In another illustrative example where the identity of the first user 102 is authenticated as the prospective buyer of the property 152, the first user 102 may have read-only privileges associated with the property profile A 128.

In other examples, the project management application 110 may notify the second user 160 of the request from the first user 102. The second user 160 may be associated with a second access level to the property profile A 128 based on an authenticated identity of the second user 160. As explained, the identity of the second user 160 may be authenticated as the administrator, the owner of the property 152, the tenant of the property 152, the prospective buyer of the property 152, the prospective tenant of the property 152, the prospective vendor for the property 154, the vendor of the property 152, the landlord of the property 152, or the prospective landlord of the property 152. The second access level associated with the second user 160 may be higher than the first access level associated with the first user 102. In additional examples, the second access level associated with the second user 160 may be lower than the first access level associated with the first user 102. In further examples, the first and the second access levels may be identical.

Then, the project management application 110 may receive, from the second user 160, one or more modifications to the property profile A 128 based on the request of the first user 102. In this illustrative example, assuming that the identity of the second user 160 is authenticated as the administrator, the second user 160 may perform one or more modifications to the property profile A 128 based on the request. The one or more modifications may include: entering a service ticket associated with a project to be performed on the property 152, modifying the service ticket associated with the project to be performed on the property 152, monitoring a status of the service ticket associated with the project to be performed on the property 152, deleing the service ticket associated with the project performed on the property 152, entering a subset of the identifiable information 130 associated with the property 152, modifying the subset of the identifiable information 130 associated with the property 152, deleting the subset of the identifiable information 130 associated with the property 152, removing one or more documents associated with the property 152, modifying the one or more documents associated with the property 152, and/or uploading the one or more documents associated with the property 152. It should be appreciated that the one or more modifications are not limited to those explicitly listed herein.

Once the second user 160 has completed the one or more modifications, the project management application 110 may transmit the modified property profile to the property database 114 for storage and may also transmit the modified property profile to the client portal 112 for display to the first user 102.

In another illustrative example, assuming that the identity of the second user 160 is authenticated as the vendor, the second user 160 may perform the one or more modifications to the property profile A 128 based on the request. However, the one or more modifications performed by the administrator may differ from the one or more modifications performed by the vendor. In this example, the one or more modifications of the vendor may include reading a service ticket of a project associated with the property 152 and/or modifying a status of the service ticket of the property 152. It should be appreciated that the one or more modifications are not limited to those explicitly listed herein. Once the second user 160 has completed the one or more modifications, the project management application 110 may transmit the modified property profile to the property database 114 for storage and may also transmit the modified property profile to the client portal 112 for display to the first user 102.

It should be appreciated that in some embodiments, the property management application 110 may be a property management engine, module, or service. In some embodiments of the instant invention, the method for managing property profiles 116 may additionally provide the afore-mentioned process steps on a subscription, advertising, and/or fee basis. That is, a service provider can offer to assist in the method steps of managing property profiles. In this case, the service provider can create, maintain, and/or support, etc. a computer infrastructure that performs the process steps for one or more customers, such as the first user 102 and/or the second user 160. In return, the service provider can receive payment from the customer(s) under a subscription and/or fee agreement, and/or the service provider can receive payment from the sale of advertising content to one or more third-parties.

FIG. 2 illustrates a detailed block diagram of a client portal of a computing device, the computing device being configured to execute a method for managing property profiles, in accordance with embodiments of the present invention. FIG. 3 illustrates a detailed block diagram of a property database configured to communicate with a computing device, the computing device being configured to execute a method for managing property profiles, in accordance with embodiments of the present invention.

According to FIG. 2, a detailed block diagram 200 of a client portal 112 of a computing device 104 (of FIG. 1) is depicted. According to FIG. 3, a detailed block diagram of the property database 114 configured to communicate with the computing device 104 (of FIG. 1) is depicted. The computing device 104 is configured to execute a method for managing property profiles 116. The computing device 104 may include a property management application 110. The property management application 110 may comprise a client portal 112, as discussed infra.

The property management application 110 may receive, via the client portal 112 of the property management application 110, login credentials from the first user 102 to access the client portal 112. The login credentials may include a username, a password, a name of the first user 102, and/or a fingerprint authentication, among other login credentials not explicitly listed herein. Then, the property management application 110 may authenticate an identity of the first user 102 based on the login credentials.

The first user 102 may engage with the client portal 112 to access one or more engines or modules, such as a planning engine 120, an alert engine 122, a development engine 124, a payment transaction engine 156, an information engine 158, and/or a construction engine 126 to request one or more service items be performed on the property 152 or to view the one or more service items that have been performed on the property 152 at one time or another. It should be appreciated that the client portal 112 may include additional engines and/or modules not explicitly listed herein.

In an example, the client portal 112 may include the planning engine 120, which may be configured to allow the first user 102 to request: a plan associated with a repair project (e.g., a remodeling project) to be executed on the property 152, calculation of a cost of an inspection of the property 152, and/or calculation a cost of the repair project to be performed on the property 152. In another example, the client portal 112 may include the alert engine 122. The alert engine 122 may be configured to display a crime alert, a weather alert (e.g., a thunderstorm alert, a hurricane alert, a flood alert, etc.), and/or a public safety alert responsive to the request from the first user 102. The crime alert, the weather alert, and/or the public safety alert may be displayed on the GUI 106 of the computing device 104 as a notification.

In a further example, the client portal 112 may include the development engine 124. The development engine 124 may house building code information. In some examples, the building code information may include NYC DOB code information. Moreover, the development engine 124 may receive the request from the first user 102, where the request includes one or more development services to be performed on the property 152. The development services may include: surveying services, monitoring services, architectural services, engineering services, inspection services, consulting services, filing services, and/or representative services, among other services not explicitly listed herein. In other examples, the request from the first user 102 may include a query for the building code information and/or building code requirements for a building located on the property 152.

In some embodiments, the client portal 112 may include the construction engine 126. The construction engine 126 may receive the request from the first user 102, where the request may be associated with one or more construction services to be performed on the property 152. The construction services may include: general contracting services, contracting services, construction management services, superintendent services, plumbing services, and/or property maintenance services, among other services not explicitly listed herein.

In a further embodiment, the client portal 112 may include the payment transaction engine 156. The payment transaction engine 156 may receive the request from the first user 102, which may include a request to process a payment from the first user 102 for one or more services rendered on the property 152. In another embodiment, the client portal 112 may include the information engine 158 that may be configured to receive the request from the first user 102. The request from the first user 102 may include a query of the building code information.

In some examples, one or more engines of the client portal 112 may receive a first request and a second request from the first user 102 during a time period. For example, the construction engine 126 may receive the first request from the first user 102 for a maintenance service to be performed on the property 152 and the development engine 124 may receive the second request from the first user 102 for a monitoring service (e.g., monitor the property 152 for any potential violations) to be performed on the property 152.

In response, the project management application 110 may notify the second user 160, who is authenticated as the administrator for illustrative purposes, of the maintenance request. The second user 160 may access an external database to identify one or more licensed or certified individuals to service the maintenance service request of the first user 102. Once the maintenance service request has been resolved, the second user 160 may modify the property profile A 128 to remove the maintenance service request. The project management application 110 may then transmit the modified property profile to the property database 114 for storage and may transmit another alert to the first user 102 to notify the first user 102 of completion and removal of the maintenance request.

Also during this time period, the project management application 110 may notify the second user 160 of the monitoring request of the first user 102. The second user 160 may access the external database to identify one or more licensed or certified individuals to monitor any potential violations of the property 152. The one or more licensed or certified individuals may monitor elevator violations, fire alarm violations, boiler violations, sprinkler violations, and/or reduced pressure zone (RPZ) valve violations, etc. of the property 152 issued by one or more agencies, such as the NYC DOB, the FDNY, the DSNY, the HPD, the DOH, and/or the NYC DEP, among others. In response to identifying one or more detected violations, the second user 160 may modify the property profile A 128 to include these one or more violations. The project management application 110 may transmit an alert or a notification of the one or more detected violations to the first user 102 that may be displayed via the client portal 112.

The second user 160 may then assign one or more individuals having requisite licenses and/or certifications to attend any necessary violation hearings (e.g., at the NYC Office of Administrative Trials and Hearings/Environmental Control Board (OATH/ECB)) to address the one or more detected violations on behalf of the first user 102. Once the one or more detected violations have been resolved, the second user 160 may modify the property profile A 128 to mark the one or more violations as addressed and resolved. The project management application 110 may then transmit the modified property profile to the property database 114 for storage and may transmit another alert to the first user 102 to notify the first user 102 of completion and removal of the one or more violations.

It should be appreciated that the examples described herein are non-exhaustive and other examples and embodiments of the instant invention are contemplated.

FIG. 4 is a block diagram of a computing device configured to manage property profiles, in accordance with embodiments of the present invention.

In some embodiments, the present invention may be a computer system, a method, and/or a computing device. For example, the computer system and/or the computing device may be utilized to implement a method for managing property profiles. A basic configuration 402 of a computing device 400 is illustrated in FIG. 4 by those components within the inner dashed line. In the basic configuration 402 of the computing device 400, the computing device 400 includes a processor 404 and a system memory 406. In some examples, the computing device 400 may include one or more processors and the system memory 406. A memory bus 408 is used for communicating between the one or more processors 404 and the system memory 406.

Depending on the desired configuration, the processor 404 may be of any type, including, but not limited to, a microprocessor (μP), a microcontroller (μC), and a digital signal processor (DSP), or any combination thereof. Further, the processor 404 may include one more levels of caching, such as a level cache memory 412, a processor core 414, and registers 416, among other examples. The processor core 414 may include an arithmetic logic unit (ALU), a floating point unit (FPU), and/or a digital signal processing core (DSP Core), or any combination thereof. A memory controller 418 may be used with the processor 404, or, in some implementations, the memory controller 418 may be an internal part of the memory controller 404.

Depending on the desired configuration, the system memory 406 may be of any type, including, but not limited to, volatile memory (such as RAM), and/or non-volatile memory (such as ROM, flash memory, etc.), or any combination thereof. The system memory 406 includes an operating system 420, one or more engines, such as a property management application 423, and program data 424. In some embodiments, the property management application 423 may be a property management engine or a property management service.

The property management application 423 may receive, via the client portal 112, login credentials from the first user 102 to access the client portal 112. The property management application 423 may then authenticate an identity of the first user 102 based on the login credentials. Next, the property management application 423 may receive, via the client portal 112, a request associated with the property 152 from the first user 102, the property 152 including a first unique identifier 154. Then, the property management application 423 may transmit the request to the property database 114 housing property profiles 116.

The property management application 423 then receives, from the property database 114, a property profile (e.g., the property profile A 128) housing identifiable information 130 associated with the property 152 and having a second unique identifier 132 that matches the first unique identifier 154 of the property 152. Then, the property management application 423 may transmit the property profile (e.g., the property profile A 128) to the client portal 112 for display to the first user 102 on the GUI 106 of the computing device 104. The property management application 423 may also grant the first user 102 a first access level to the property profile (e.g., the property profile A 128) based on the authenticated identity of the first user 102. Moreover, the property management application 423 may notify a second user 160 of the request from the first user 102. The second user 160 has a second access level to the property profile (e.g., the property profile A 128) based on an authenticated identity of the second user 160. The property management application 423 may then receive, from the second user 160, one or more modifications to the property profile e.g., the property profile A 128) based on the request of the first user 102.

Moreover, the computing device 400 may have additional features or functionality, and additional interfaces to facilitate communications between the basic configuration 402 and any desired devices and interfaces. For example, a bus/interface controller 430 is used to facilitate communications between the basic configuration 402 and data storage devices 432 via a storage interface bus 434. The data storage devices 432 may be one or more removable storage devices 436, one or more non-removable storage devices 438, or a combination thereof. Examples of the one or more removable storage devices 436 and the one or more non-removable storage devices 438 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 440 facilitates communication from various interface devices (e.g., one or more output devices 442, one or more peripheral interfaces 444, and one or more communication devices 466) to the basic configuration 402 via the bus/interface controller 430. Some of the one or more output devices 442 include a graphics processing unit 448 and an audio processing unit 450, which are configured to communicate to various external devices, such as a display or speakers, via one or more A/V ports 452. The one or more peripheral interfaces 444 may include a serial interface controller 454 or a parallel interface controller 456, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 458. Further, the one or more communication devices 466 may include a network controller 460, which is arranged to facilitate communication with one or more other computing devices 462 over a network communication link via one or more communication ports 464. The one or more other computing devices 462 include servers, the database 106, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 406, the one or more removable storage devices 436, and the one or more non-removable storage devices 438 are examples of the computer-readable storage media. The computer-readable storage media is a tangible device that can retain and store instructions (e.g., program code) for use by an instruction execution device (e.g., the computing device 400). Any such, computer storage media is part of the computing device 400.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 404 of a general purpose computer, special purpose computer, or other programmable data processing apparatus (e.g., the computing device 400) to produce a machine, such that the instructions, which execute via the processor 404 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 400), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block of the block diagrams and combinations of blocks in the block diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. A method executed by a property monitoring application on a computing device for managing property alerts, the method comprising:
receiving, via a client portal associated with the property monitoring application, login credentials from a first user to access the client portal, wherein the client portal comprises a development engine, an alert engine, and at least one other engine;
authenticating an identity of the first user based on the login credentials;
receiving, via the development engine of the client portal, a request for a monitoring service to be performed on a property from the first user, the property including a first unique identifier;
transmitting the request to a property database housing property profiles;
receiving, from the property database, a property profile housing identifiable information associated with the property and having a second unique identifier that matches the first unique identifier of the property;
transmitting the property profile to the client portal for display to the first user on a graphical user interface (GUI) of the computing device;
granting the first user a first access level to the property profile based on the authenticated identity of the first user;
notifying a second user of the request from the first user, wherein the second user has a second access level to the property profile based on an authenticated identity of the second user;
receiving, from the second user, one or more modifications to the property profile,
wherein the one or more modifications to the property profile comprise entering one or more licensed or certified individuals to monitor violations of the property and entering the violations of the property identified by the one or more licensed or certified individuals,
wherein the one or more licensed or certified individuals are identified in response to the second user accessing an external database, and
wherein the identified violations comprise at least three of: a building code violation, a fire code violation, an environmental code violation, and a safety/public health code violation;
transmitting a first alert or a first notification of the identified violations and the one or more licensed or certified individuals monitoring the violations to the client portal for display to the first user on the GUI of the computing device;
receiving, from the second user, a second alert or a second notification that the identified violations are resolved in response to the one or more licensed or certified individuals attending violation hearings to resolve the identified violations;
transmitting the second alert or the second notification to the client portal for display to the first user on the GUI of the computing device;
receiving, via the alert engine, another request associated with the property from the first user, wherein the other request includes a crime alert associated with the property; and
transmitting a third alert or a third notification of the crime alert to the client portal for display to the first user on the GUI of the computing device.

2. The method of claim 1, wherein the second access level is higher than the first access level.

3. The method of claim 1, wherein the at least one other engine is selected from the group consisting of: a planning engine, a construction engine, a payment transaction engine, and an information engine.

4. The method of claim 1,
wherein the at least one other engine comprises a planning engine,
wherein the method further comprises receiving, via the planning engine of the client portal, another request associated with the property from the first user, and
wherein the other request includes one or more of: a plan associated with a repair project for the property, a calculation of a cost of an inspection of the property, and/or a calculation of a cost of a repair project of the property.

5.-6. (canceled)

7. The method of claim 1,
wherein the development engine houses building code information,
wherein the method further comprises receiving, via the development engine of the client portal, another request associated with the property from the first user, and
wherein the other request includes the building code information or building code requirements for a building located on the property.

8. The method of claim 1,
wherein the at least one other engine comprises a construction engine,
wherein the method further comprises receiving, via the construction engine of the client portal, another request associated with the property from the first user, and
wherein the other request is associated with a construction service to be performed on the property.

9. The method of claim 8, wherein the construction service is selected from the group consisting of: a general contracting service, a contracting service, a construction management service, a superintendent service, a plumbing service, and a property maintenance service.

10. A computer system comprising one or more processors, one or more memories, and one or more computer-readable hardware storage devices, the one or more computer-readable hardware storage devices containing program code executable by the one or more processors via the one or more memories to implement a method for managing property alerts, the method comprising:
receiving, via a client portal, login credentials from a first user to access the client portal, wherein the client portal comprises a development engine, an alert engine, and at least one other engine;
authenticating an identity of the first user based on the login credentials;
receiving, via the development engine of the client portal, a request for a monitoring service to be performed on a property from the first user, the property including a first unique identifier;
transmitting the request to a property database housing property profiles;
receiving, from the property database, a property profile housing identifiable information associated with the property and having a second unique identifier that matches the first unique identifier of the property;
transmitting the property profile to the client portal for display to the first user on a graphical user interface (GUI) of the computer system;
granting the first user a first access level to the property profile based on the authenticated identity of the first user;
notifying a second user of the request from the first user, wherein the second user has a second access level to the property profile based on an authenticated identity of the second user;
receiving, from the second user, one or more modifications to the property profile,
wherein the one or more modifications to the property profile comprise entering one or more licensed or certified individuals to monitor violations of the property and entering the violations of the property identified by the one or more licensed or certified individuals,
wherein the one or more licensed or certified individuals are identified in response to the second user accessing an external database, and
wherein the identified violations comprise at least three of: a building code violation, a fire code violation, an environmental code violation, and a safety/public health code violation;
transmitting a first alert or a first notification of the identified violations and the one or more licensed or certified individuals monitoring the violations to the client portal for display to the first user on the GUI of the computer system;
receiving, from the second user, a second alert or a second notification that the identified violations are resolved in response to the one or more licensed or certified individuals attending violation hearings to resolve the identified violations;
transmitting the second alert or the second notification to the client portal for display to the first user on the GUI of the computing device;
receiving, via the alert engine, another request associated with the property from the first user, wherein the other request includes a crime alert associated with the property; and
transmitting a third alert or a third notification of the crime alert to the client portal for display to the first user on the GUI of the computing device.

11. The computer system of claim 10,
wherein the identifiable information is selected from the group consisting of: one or more photographs associated with the property, one or more videos associated with the property, the unique identifier associated with the property, an address of the property, financial information associated with the property, owners of the property, contact information associated with the property, pending projects associated with the property, completed projects associated with the property, and a listing of other properties similar to the property.

12. The computer system of claim 10,
wherein the at least one other engine comprises a payment transaction engine,
wherein the method further comprises receiving, via the payment transaction engine of the client portal, another request associated with the property from the first user, and
wherein the other request is a payment processing request from the first user for one or more services rendered on the property.

13. The computer system of claim 11,
wherein the at least one other engine comprises an information engine,
wherein the method further comprises receiving, via the information engine of the client portal, another request associated with the property from the first user, and
wherein the other request comprises an inquiry of building code information associated with the property.

14. A computing device comprising one or more processors, one or more memories, and one or more computer-readable hardware storage devices, the one or more computer-readable hardware storage devices containing program code executable by the one or more processors via the one or more memories to implement a method for managing property alerts, the method comprising:
receiving, via a client portal, login credentials from a first user to access the client portal, wherein the client portal comprises a development engine, an alert engine, and at least one other engine;
authenticating an identity of the first user based on the login credentials;
receiving, via the development engine of the client portal, a request for a monitoring service to be performed on a property from the first user, the property including a first unique identifier;
transmitting the request to a property database housing property profiles;
receiving, from the property database, a property profile housing identifiable information associated with the property and having a second unique identifier that matches the first unique identifier of the property;
transmitting the property profile to the client portal for display to the first user on a graphical user interface (GUI) of the computing device;
granting the first user a first access level to the property profile based on the authenticated identity of the first user;
notifying a second user of the request from the first user, wherein the second user has a second access level to the property profile based on an authenticated identity of the second user;
receiving, from the second user, one or more modifications to the property profile,
wherein the one or more modifications to the property profile comprise: entering one or more licensed or certified individuals to monitor violations of the property, entering the violations of the property identified by the one or more licensed or certified individuals, and entering an assignment of one or more individuals having licenses and/or certifications to attend violation hearings to address the identified violations on behalf of the first user;
wherein the one or more licensed or certified individuals are identified in response to the second user accessing an external database, and
wherein the identified violations comprise at least three of: a building code violation, a fire code violation, an environmental code violation, and a safety/public health code violation;
transmitting a first alert or a first notification of the identified violations, the one or more licensed or certified individuals, and the assignment of the one or more individuals to the client portal for display to the first user on the GUI of the computer system;
receiving, from the second user, a second alert or a second notification that the identified violations are resolved in response to the one or more licensed or certified individuals attending violation hearings to resolve the identified violations;
transmitting the second alert or the second notification to the client portal for display to the first user on the GUI of the computing device;
receiving, via the alert engine, another request associated with the property from the first user, wherein the other request includes a crime alert associated with the property; and
transmitting a third alert or a third notification of the crime alert to the client portal for display to the first user on the GUI of the computing device.

15. The computing device of claim 14, wherein the second access level is higher than the first access level.

16. The computing device of claim 14, wherein the identity of the second user is authenticated as an administrator, an owner of the property, a tenant, a prospective buyer of the property, a prospective tenant of the property, a prospective vendor for the property, a vendor, a landlord, or a prospective landlord of the property.

17. The computing device of claim 16,
wherein the identity of the second user is authenticated as the administrator, and
wherein the one or more modifications to the property profile further comprise at least one of: entering a service ticket associated with a project to be performed on the property, modifying the service ticket associated with the project to be performed on the property, monitoring a status of the service ticket associated with the project to be performed on the property, deleing the service ticket associated with the project performed on the property, entering a subset of the identifiable information associated with the property, modifying the subset of the identifiable information associated with the property, deleting the subset of the identifiable information associated with the property, removing one or more documents associated with the property, modifying the one or more documents associated with the property, and uploading the one or more documents associated with the property.

18. The computing device of claim 17, wherein the method further comprises:
transmitting the modified property profile to the property database for storage; and
transmitting the modified property profile to the client portal for display to the first user.

19. The computing device of claim 16,
wherein the identity of the second user is authenticated as the vendor, and
wherein the one or more modifications to the property profile further comprise at least one of: reading a service ticket of a project associated with the property and modifying a status of the service ticket of the property.

20. The computing device of claim 19, wherein the method further comprises:
transmitting the modified property profile to the property database for storage; and
transmitting the modified property profile to the client portal for display to the first user.
